(19) United States
(12) Patent Application Publication
(10) Pub. No.: US 2003/0227490 A1
(43) Pub. Date: Dec. 11, 2003

(54) Control apparatus and method of display device

(75) Inventor: Yong-jae Kim, Paldal-gu (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd. of Republic of Korea, Suwon-city (KR)

(21) Appl. No.: 10/428,083

(22) Filed: May 2, 2003

(30) Foreign Application Priority Data
Jun. 8, 2002 (KR) 2002-32181

(51) Int. Cl. G09G 5/00

(52) U.S. Cl. 345/810

(57) ABSTRACT

A control apparatus and a method of controlling a variety of functions of a display device, including on screen display (OSD) application programs, according to a control value input through an input unit attached to a computer. The functions including communication using OSD hardware and software between the display device and the computer are designed to be controlled by the input unit of the computer connected to the display device through a USB port such that separate buttons on the display device are not needed, and a structure of the display device is simplified. Also, since an OSD module of the display device is used without change and without complicated OSD application programs, and the display device can be controlled by an external apparatus connected to the display device, a development period of the display device can be shortened. Particularly, even when distortion occurs due to twisted (deviated) setting states of a screen of the display device, the OSD application programs can be normally executed.

### CROSS-REFERENCE TO RELATED APPLICATIONS

This application claims the benefit of Korean Application No. 2002-57576, filed Sep. 23, 2002, in the Korean Intellectual Property Office, the disclosure of which is incorporated herein by reference.

### BACKGROUND OF THE INVENTION

1. Field of the Invention

The present invention relates to display control apparatus and method, and more particularly, to control apparatus and method of controlling a variety of functions of a display device, including on screen display (OSD) application programs, according to a control value input through an input unit of a computer coupled to the display device.

2. Description of the Related Art

In changing display setting values, such as a size of a screen, brightness, contrast, and visibility, in a related art display device, an OSD menu screen is used, and there are two methods of controlling the OSD menu screen in a display device.

The two methods are a direct control method using buttons of a monitor and an indirect control method in which, using an OSD program in an external computer, the OSD menu screen is displayed on a computer monitor, and desired changes in the display setting values are transferred to the computer monitor from the external computer through a universal serial bus (USB) interface.

As shown in FIG. 1, a display device using the direct control method includes a signal processing unit 110, an OSD mixing unit 120, a monitor control unit 130, an OSD module 140, a key input unit 150, and a memory 160.

In the memory 160, monitor display setting values including a size of a screen, brightness, contrast, visibility, that are set using an OSD menu are stored.

The signal processing unit 110 converts a first signal, which is input from an external apparatus, into a digital signal, converts the digital signal into a second signal complying with R, G, B types, compresses or extends the second signal into R, G, B data having resolution complying with display specifications, and then outputs the R, G, B data. By doing this process, the signal processing unit 110 performs signal processing.

The key input unit 150 is attached to the display device (monitor), generally has key buttons for inputting information needed in executing the OSD menu, and includes a menu key button, a +/− key button, and a set key button.

The monitor control unit 130 controls the OSD module 140 according to a key value input through the key input unit 150, generates an OSD screen to change the monitor display setting values according to the OSD menu, and outputs the OSD screen to the OSD mixing unit 120.

Then, the OSD mixing unit 120 mixes the R, G, B data output from the signal processing unit 110 with an OSD screen signal output from the OSD module 140, and displays a mixed scene on a display unit such as an LCD panel.

The monitor control unit 130 updates display specifications selected on the displayed OSD screen, by replacing the monitor display setting values stored in the memory 160 with new monitor display setting values input through the key input unit 150.

However, in this related art direct control method, in order to control the OSD menu, buttons attached to the monitor should be manually manipulated and this causes an inconvenience to users.

Also, in the related art indirect control method, if an input image is not correctly displayed due to abnormal screen setting values of the display device, the OSD menu itself is not displayed, and when a signal that cannot be processed by the display device is input to the display device, an OSD application program of the computer cannot be normally executed due to distortion of the screen.

### SUMMARY OF THE INVENTION

To solve the above and/or other problems, it is an aspect of the present invention to provide control apparatus and method of controlling an OSD module contained in a circuit installed in a display device according to information input by an input unit of a computer through a USB interface coupled between the display device and the computer.

Additional aspects and advantages of the invention will be set forth in part in the description which follows and, in part, will be obvious from the description, or may be learned by practice of the invention.

According to an aspect of the present invention, an on screen display (OSD) control apparatus of a display device includes an OSD module which generates a menu screen signal to set display state information of the display device according to an OSD control command, an interface unit which performs data communications between the display device and a computer coupled to the display device, and a display control unit which controls the OSD module according to OSD control information of the computer that is received through the interface unit, and transmits information indicating an output state of an OSD menu screen to the computer through the interface unit.

According to another aspect of the present invention, a method of controlling an OSD module installed in a display device includes determining whether OSD control information of a computer is sent through an interface unit while performing communications with the computer, analyzing the OSD control information, generating a control command to control the OSD module according to the analyzed result, and controlling the OSD module according to the control command.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a diagram of a structure of an OSD control apparatus of a conventional monitor;

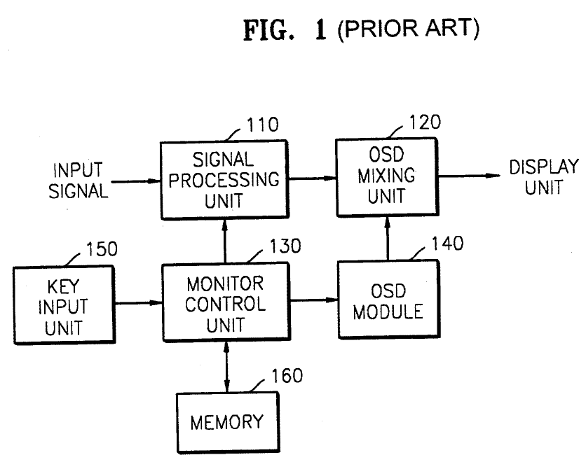

FIG. 2 is a diagram of a structure of an OSD control apparatus of a display device according to an embodiment of the present invention;

FIG. 3 is a schematic flowchart showing an OSD control method performed in the display device shown in FIG. 2; and

FIG. 4 is a detailed flowchart showing the OSD control method shown in FIG. 3.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

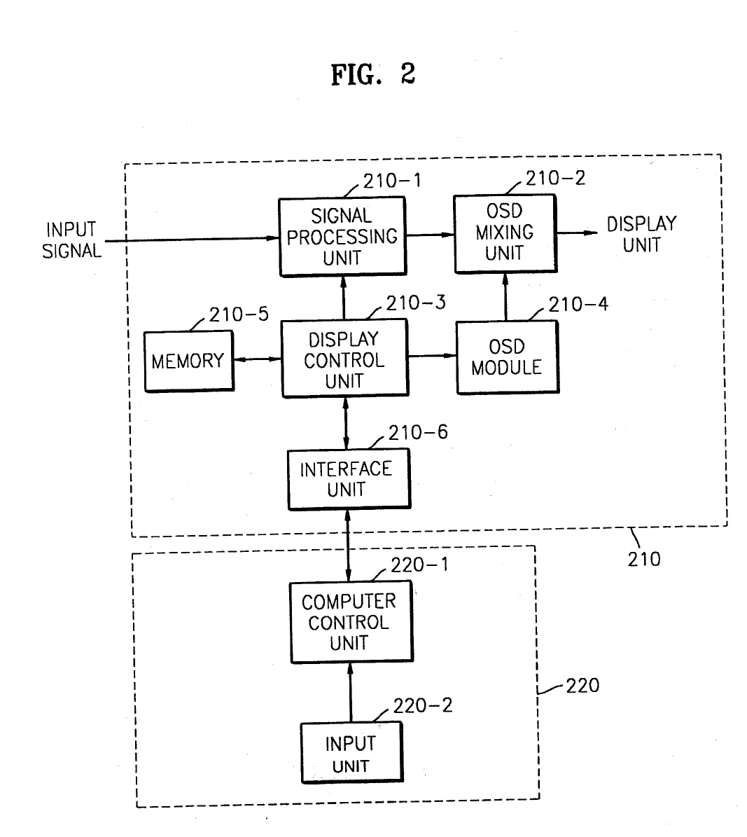

As shown in FIG. 2, an OSD control apparatus of a display device according to an embodiment of the present invention includes a signal processing unit 210-1, an OSD mixing unit 210-2, a display control unit 210-3, an OSD module 210-4, an interface unit 210-5, a computer control unit 220-1, and an input unit 220-2.

Among the above modules of the OSD control apparatus, the signal processing unit 210-1, the OSD mixing unit 210-2, the display control unit 210-3, the OSD module 210-4, and the interface unit 210-5 are included in a display device 210, and the computer control unit 220-1 and the input unit 220-2 are included in a computer 220.

More specifically, the signal processing unit 210-1 includes an analog/digital conversion circuit, a format converting circuit, and a scaler (scaling) circuit. The signal processing unit 210-1 receives input signals provided by signal providing apparatuses, such as the computer 220 connected to the display device 210, converts the received input signals into digital signals, then converts the digital signals into R, G, B type signals, compresses or extends the R, G, B type signals into R, G, B data having a resolution complying with display specifications, and then outputs the R, G, B data. By doing this process, the signal processing unit 210-1 performs signal processing.

The display control unit 210-3 sends OSD state information indicating an OSD output state to the computer control unit 220-1 through the interface unit 210-6. By analyzing OSD control information sent by the computer control unit 220-1 through the interface unit 210-6, the display control unit 210-3 generates an OSD control command to control the OSD module 210-4.

Then, while an OSD graphic screen (OSD menu or OSD menu screen) is output, the display control unit 210-3 analyzes event information (coordinates of a cursor and a state of a button) of a mouse, which is provided by the computer control unit 220-1, and according to a result of the analysis, controls the OSD module 210-4, and updates display setting values, which have been changed, in the memory 210-5.

When a display setting environment is desired to be changed, the OSD module 210-4 generates the OSD graphic screen by displaying display setting specifications, such as horizontal and vertical sizes, or horizontal and vertical positions, contrast, brightness, or visibility, in letters and figure shape graphics according to an OSD control signal provided by the display control unit 210-3, so that a user of the display device can determine the display setting specifications with confirmation on a OSD graphic screen.

The OSD mixing unit 210-2 performs overlapping processing for a first signal (the R, G, B data output from the signal processing unit 210-1 and a second signal (OSD graphic screen) output from the OSD module 210-4, and displays a result of the overlapping processing on a display unit such as an LCD panel.

In the memory 210-5, setting values of the display setting specifications that are set through the OSD menu, such as the brightness, the contrast, or the visibility, are stored.

The interface unit 210-6 enables data communications between the display control unit 210-3 and the computer control unit 220-1 through a USB port in a polling method or an interrupt method. Here, the computer 220 operates as a USB host while the display device 210 operates as a USB device. Also, other interface methods, such as a serial method and a DDC method may be applied to the interface unit 210-6.

The input unit 220-2 of the computer 220 is a unit through which data is inputted to change the setting values of the display setting specifications by using the OSD menu, and includes a keyboard and the mouse.

The computer control unit 220-1 generates the OSD control information to control the OSD menu according to a key value input from the input unit 220-2, and sends the OSD control information to the interface unit 210-6. Particularly, the computer control unit 220-1 confirms whether the OSD graphic screen is output. If the OSD graphic screen is output, and the cursor of the mouse moves on the OSD graphic screen, the computer control unit 220-1 controls the computer 220 so that the event information (a movement of the cursor and a button state) of the mouse is sent to the display control unit 210-3 through the interface unit 210-6.

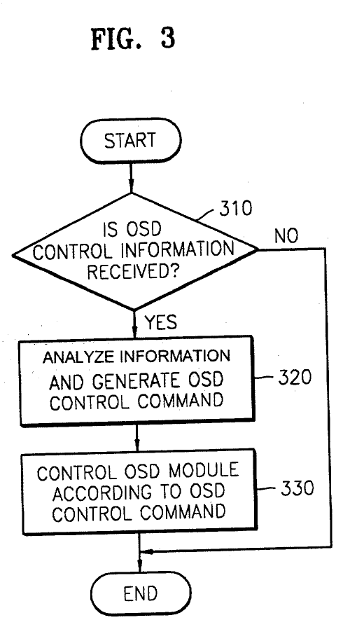

Next, referring to a schematic flowchart of FIG. 3, an OSD control method performed in the display device 210 will now be explained referring to the diagram of the structure of the display control apparatus of FIG. 2.

First, it is determined whether the OSD control information is received by the display control unit 210-3 through the interface unit 210-6 in operation 310. That is, it is determined whether the OSD control information generated in the computer control unit 220-1 by a key manipulation and a mouse movement of the input unit 220-2 of the computer 220 is input through the interface unit 210-6.

Then, the received OSD control information is analyzed in the display control unit 210-3, and the OSD control command corresponding to the analyzed result is generated in operation 320.

According to the OSD control command, the OSD module 210-4 is controlled so that the OSD menu screen changes, or, if the OSD control command is for changing the setting values of the display setting specifications, the setting values of the display setting specifications stored in the memory 210-5 corresponding to the OSD control command are updated in operation 470.

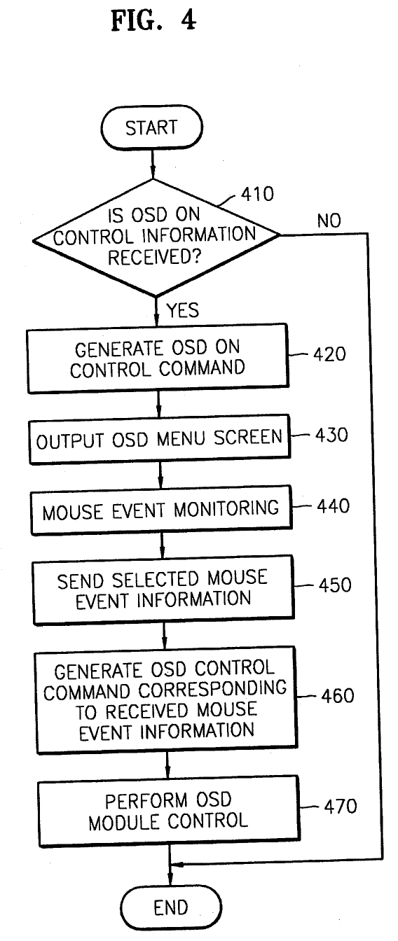

Next, referring to a detailed flowchart of FIG. 4, the OSD control method performed in the display device 210 will now be explained referring to the diagram of the structure of FIG. 2.

First, it is determined whether OSD ON control information is received by the display control unit 210-3 through the interface unit 210-6 in operation 410. That is, it is determined whether the OSD ON control information which is generated in the computer control unit 220-1 by key manipulation of the input unit 220-2 of the computer 220 is input through the interface unit 210-6.

If the OSD ON control information is input to the display control unit 210-3 through the interface unit 210-6, the display control unit 210-3 generates an OSD ON control command (OSD control command) so that the OSD menu screen is displayed in operation 420.

Then, according to the OSD ON control command, the OSD module 210-4 performs graphic processing to generate the OSD menu screen, and outputs a result of the graphic processing to the OSD mixing unit 210-2. Then, in the OSD mixing unit 210-2, the OSD menu screen output from the OSD module 210-4 overlaps the signal (R, G, B data) output from the signal processing unit 210-1, and outputs the result of the overlapping to the display unit in step 430.

Thus, if the OSD menu screen is output, the display control unit 210-3 sends the OSD state information indicating that the OSD menu screen is output, to the computer control unit 220-1 through the interface unit 210-6, and then, the computer control unit 220-1 monitors the event information on an event (the coordinates of the cursor, and the state of the button) of the mouse in operation 440.

If the result of monitoring indicates that one function in the OSD menu screen is selected by a button input, selected event information of the mouse is sent to the display control unit 210-3 through the interface unit 210-6 in operation 450.

Then, the display control unit 210-3 analyzes the received event information of the mouse, and generates the OSD control command corresponding to the result of the analysis in operation 460.

Then, according to the OSD control command, the OSD module 210-4 is controlled so that the OSD menu screen changes, or, if the control command is for changing the display setting values, the setting values of the display specifications stored in the memory 210-5 are updated in operation 330.

Thus, by an OSD control operation, the OSD module 140 in the display device can be indirectly controlled by using information input from the input unit of the computer through the USB interface.

For convenience of explanation and as an example of the present invention, the apparatus for and method of controlling the OSD module 140 of the display device 210 using the external computer 220 are described. However, it is clear to a skilled person in the art that the present invention can be applied to an apparatus for and a method of controlling a circuit which processes functions other than the OSD module of the display device 210.

As described above, according to the present invention, a variety of functions including OSD hardware and software in a display device, are designed to be controlled by an input unit of a computer connected to the display device through a USB port such that separate buttons on the display device are not needed, and a structure of the display device is simplified. Also, since an OSD module of the display device is used without change and without complicated OSD application programs, and the display device can be controlled by an external apparatus connected to the display device, a development period of the display device can be shortened. Particularly, when distortion occurs due to twisted (distorted or deviated) setting states of a screen of the display device, the OSD application programs can be normally executed.

The present invention may be embodied in a code, which can be read by a computer, on a computer readable recording medium. The computer readable recording medium includes all kinds of recording apparatuses on which computer readable data are stored.

The computer readable recording media includes storage media such as magnetic storage media e.g., ROM's, floppy disks, hard disks, etc., optically readable media, e.g., CD-ROMs, DVDs, etc., or carrier waves, e.g., transmissions over the Internet. Also, the computer readable recording media can be distributed to computer systems connected through a network and can store and execute a computer readable code in a distributed mode. It is noted that the present invention is not limited to the preferred embodiment described above, and it is apparent that variations and modifications by those skilled in the art can be effected within the spirit and scope of the present invention defined in the appended claims and their equivalents.

What is claimed is:

1. An on screen display (OSD) control apparatus of a display device coupled to a computer, comprising:
an OSD module which generates a menu screen signal to set display state information of the display device according to an OSD control command;
an interface unit which performs data communications between the display device and the computer; and
a display control unit which controls the OSD module according to OSD control information of the computer that is received through the interface unit, and outputs OSD state information indicating an output state of an OSD menu screen, to the computer through the interface unit.

2. The OSD control apparatus of claim 1, wherein the computer comprises a mouse, and the OSD control information comprises event information indicating movement and selection states of the mouse.

3. The OSD control apparatus of claim 2, wherein the OSD menu screen comprises buttons, and the event information of the mouse comprises information on coordinates of a cursor on the OSD menu screen and the buttons.

4. The OSD control apparatus of claim 1, wherein the interface unit comprises hardware and software using a universal serial bus (USB) interface protocol to enable the data communications between the display device and the computer.

5. An OSD control apparatus of a display device coupled to a computer, comprising:
an OSD module which is installed in the display device and generates a menu screen signal to set display state information according to an OSD control command;
an interface unit which performs data communications between the display device and the computer;
a computer input unit by which OSD control information for controlling an OSD menu of the display device is input to the OSD module through the interface unit;
a computer control unit which receives OSD state information indicating an output state of the OSD menu screen through the interface unit, and sends the OSD control information to the interface unit to control the OSD menu of the display device corresponding to the OSD control information input from the computer input unit; and
a display control unit which controls the OSD module according to OSD control information of the computer that is received through the interface unit, and outputs the OSD state information indicating the output state of the OSD menu screen to the computer through the interface unit.

6. The OSD control apparatus of claim 5, wherein:
the computer comprises,
a mouse; and
the OSD control information comprises,
event information indicating a movement and selection states of the mouse.

7. The OSD control apparatus of claim 6, wherein the display device displays an OSD menu screen and buttons, and the event information of the mouse comprises:
information on coordinates of a cursor on the OSD menu screen and buttons.

8. The OSD control apparatus of claim 5, wherein the computer control unit comprises hardware and software for performing operations comprising:
determining whether an OSD menu screen of the display device is output, by using the OSD state information indicating the output state of the OSD menu screen which is received through the interface unit; and
upon determining that the OSD menu screen is output, comparing screen coordinates of the OSD menu screen and cursor coordinates of a cursor on the OSD menu screen, and if the cursor is on the coordinates within the OSD menu screen, outputting OSD control information including the cursor coordinates of the cursor and button input information to the interface unit.

9. The OSD control apparatus of claim 5, wherein the interface unit comprises:
hardware and software using a USB interface protocol to enable the data communications.

10. A method of controlling an OSD module installed in a display device coupled to a computer, comprising:
determining whether OSD control information of the computer is outputted through an interface unit while performing data communications between the display device and the computer;
analyzing the OSD control information, and generating a control command to control the OSD module, corresponding to an analyzed result; and
controlling the OSD module according to the control command.

11. The method of claim 10, wherein the analyzing of the OSD control information comprises:
controlling an OSD menu of the display device which is generated by the computer, corresponding to information input by an input unit connected to computer.

12. The method of claim 10, wherein the determining of whether the OSD control information is outputted, comprises:
when an OSD menu screen is output, generating event information indicating a movement and selection states of a cursor using an input unit of the computer.

13. The method of claim 12, wherein the generating of the event information comprises:
generating information on the coordinates of the cursor and buttons.

14. The method of claim 10, wherein the interface unit comprises:
hardware and software using a USB interface protocol to enable the data communications.

15. A method for controlling a display device coupled to a computer comprising:
determining whether control information of the computer is outputted through an interface unit, while performing communications with the computer;
analyzing the control information, and generating a control command to control a predetermined function of the display device corresponding to an analyzed result; and
controlling the predetermined function of the display device according to the control command.

16. The method of claim 15, wherein the analyzing of the control information comprises:
generating OSD control information to control an OSD menu of the display device which is generated by the computer, corresponding to information input by an input unit connected to the computer.

17. The method of claim 15, wherein the determining of whether the control information of the computer is outputted, comprises:
when an OSD menu screen is output, generating event information indicating a movement and selection states of a cursor using an input unit of the computer.

18. The method of claim 17, wherein the generating of the event information comprises:
generating information on coordinates of the cursor and buttons.

19. The method of claim 15, wherein the interface unit comprises:
hardware and software [that enable data communications by using a USB interface protocol to enable the data communications.

20. An OSD control apparatus of a display device generating an OSD menu screen and communicating with a computer, comprising:
an interface unit connectable to the computer; and
a display control unit outputting OSD state information to the computer through the interface, receiving OSD control information from the computer through the interface unit, and generating an OSD control command to control the OSD menu screen according to the OSD control information.

21. The OSD control apparatus of claim 20, wherein the display control unit receives event information from the computer through the interface unit and generates setting values to control the OSD menu screen according to the event information.

22. The OSD control apparatus of claim 21, wherein the computer comprises a computer control unit and an input unit having one of a mouse and a keyboard, and the computer control unit outputs the event information to the interface unit according to a movement of the input unit.

23. The OSD control apparatus of claim 21, wherein the display device comprises a display panel having a screen, and the OSD menu screen is displayed on a portion of the screen of the display panel.

24. The OSD control apparatus of claim 21, wherein the display device comprises a memory storing a first display specification of the screen and a second display specification of the OSD menu screen.

25. The OSD control apparatus of claim 24, wherein and the display control unit adjusts the setting values corresponding the second display specification according to the event information.

26. The OSD control apparatus of claim 24, wherein the display control unit adjusts the setting values corresponding the second display specification with respect to the first display specification according to the event information.

27. The OSD control apparatus of claim 24, wherein the first and second display specifications comprise:
at least one of brightness, contrast, visibility, horizontal and vertical sizes, and horizontal and vertical positions.

28. The OSD control apparatus of claim 20, wherein the interface unit comprises:
a USB port.

29. A method in an OSD control apparatus of a display device generating an OSD menu screen and communicating with a computer, comprising:
causing an interface unit to be connected between the display device and the computer;
outputting OSD state information to the computer through the interface;
receiving OSD control information from the computer through the interface unit; and
generating an OSD control command to control the OSD menu screen according to the OSD control information.

30. The method of claim 29, further comprising:
receiving event information from the computer through the interface unit; and
generating setting values to control the OSD menu screen according to the event information.

31. The method of claim 30, wherein the display device comprises a display panel with a screen, and the method further comprises:
storing a first display specification of the screen and a second display specification of the OSD menu screen in a memory.

32. The method of claim 31, further comprising:
adjusting the setting values corresponding the second display specification according to the event information.

33. The method of claim 31, further comprising:
adjusting the setting values corresponding the second display specification with respect to the first display specification according to the event information.

34. A recording medium encoded with data readable by a computer to implement a method of generating an OSD menu screen in an OSD control apparatus of a display device communicating with the computer through an interface unit having a USB port, the recording medium comprising:
data used to output OSD state information to the computer through the interface;
data used to receive OSD control information from the computer through the interface unit;
data used to generate an OSD control command to control the OSD menu screen according to the OSD control information;
data used to receiving event information from the computer through the interface unit; and
data used to generate setting values to control the OSD menu screen according to the event information.

35. The recording medium of claim 34, wherein:
the display device comprises,
a display panel with a screen; and
the recording medium further comprises,
data used to store a first display specification of the screen and a second display specification of the OSD menu screen in a memory.

36. The recording medium of claim 35, wherein the recording medium comprises:
data used to adjust the setting values corresponding the second display specification according to the event information.

37. The recording medium of claim 35, wherein the recording medium comprises:
data used to adjust the setting values corresponding the second display specification with respect to the first display specification according to the event information.

38. The recording medium of claim 35, wherein the recording medium comprises:
one of a magnetic storage medium, an optically readable medium, and a carrier wave transmitted over Internet.
